(19) United States
(12) Patent Application Publication
(10) Pub. No.: US 2006/0204322 A1
(43) Pub. Date: Sep. 14, 2006

(54) Clamp device for telescopic tubes inserted one in the other

(76) Inventor: Thomas Roiser, Mondsee (AT)

Correspondence Address: YOUNG & THOMPSON, 745 SOUTH 23RD STREET, 2ND FLOOR, ARLINGTON, VA, 22202, US

(21) Appl. No.: 10/553,061

(22) PCT Filed: Oct. 21, 2004
(86) PCT No.: PCT/AT04/00360

§ 371 Date: Apr. 26, 2006

(30) Foreign Application Priority Data
Dec. 15, 2003 (AT) GM 891/2003

(51) Int. Cl. F16B 7/10

(52) U.S. Cl. 403/109.5

(57) ABSTRACT

The position of telescopic tubes inserted one in the other, for sports poles, can be fixed, whereby a clamping device is provided within the tubes. The clamping device has a clamping piece and expanding bodies, provided on both ends of the clamping piece. The expanding bodies are screwed onto a threaded rod with counter-running threads sections. On relative rotation of the tubes the expanding bodies are forced into the clamping piece from both ends thereof with an appropriate rotational direction and extend the same essentially evenly outwards over the whole length thereof such that the same rests on the inner surface of the outer tube with a frictional connection and thus fixes the length of the pole, once adjusted. The tubes can thus be fixed with less force required than usual in the desired position relative to each other.

The invention relates to a clamping device for telescoping tubes, especially poles or staffs used in sports, with a radially expandable clamping part.

These clamping device are used to fix the position of telescoping tubes relative to one another.

These devices are known for example in staffs or poles which are used in sports and which have a variable length, such as ski poles, hiking staffs and the like. For example, reference is made to AT 397 355 B and AT 404 324 B.

The known clamping devices on the inner tube have a threaded rod fixed unable to turn. A clamping part is placed over this threaded rod. The clamping part interacts with a cone which is screwed onto the threaded rod (“expansion body”). The cone adjoins the inside of the outer tube into which the inner tube is inserted in the manner of a telescope, so that when the tubes are turned to one another the cone, depending on the direction of rotation, is moved in the direction toward the expansion clamping part or away from it. By the corresponding turning the clamping part can be expanded and thus the position of the tubes to one another can be fixed. If the position is to be changed, turning takes place in the opposite direction in order to release the clamping device and a new position can be set.

The disadvantage in these known embodiments is that the expansion body acts on the clamping part only from one side so that to secure the relative position of the two tubes which form for example the pole parts to one another, a sufficient clamping action can only be achieved with a relatively great expenditure of force.

The object of the invention is to devise a clamping device which operates with an expansion clamping part for telescoping tubes, especially poles and the like, with which the required clamping action can be achieved with a lower expenditure of force than in the past.

This object is achieved with a clamping device which has the features of claim 1.

Advantageous and preferred configurations of the clamping device as claimed in the invention are the subject matter of the dependent claims.

Because in the device as claimed in the invention the expansion clamping part which causes clamping by a frictional connection between the telescoping tubes is acted up from the two sides by one cone each (expansion bodies), the clamping action is greatly improved.

Within the framework of the invention, in one preferred embodiment it can be provided that the two expansion bodies which interact with the clamping part are placed and screwed onto sections of the threaded rod have opposing threads (one left-hand thread and one right-hand thread). Thus, even for little rotary motion a relatively large axial movement of the two cones relative to the clamping part is achieved. In this embodiment, with little turning the necessary clamping force is applied to secure the two tubes, for example the pole parts, to one another in their selected relative position (corresponding to the desired length of the pole).

Other details, features and advantages of the clamping device as claimed in the invention are explained in the following description of preferred embodiments.

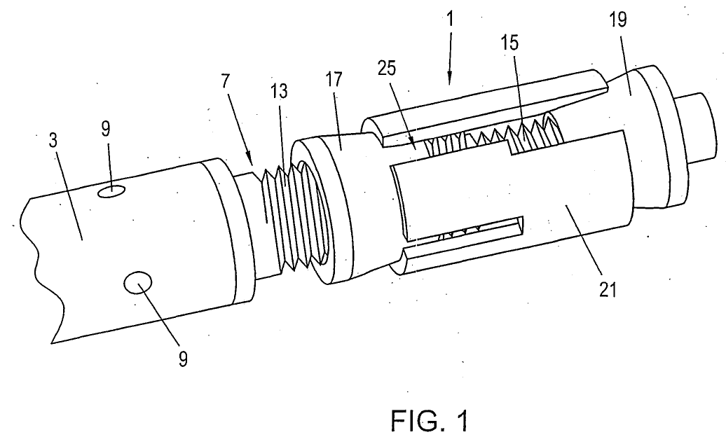

FIG. 1 shows in a perspective view a clamping device as claimed in the invention without an outer tube;

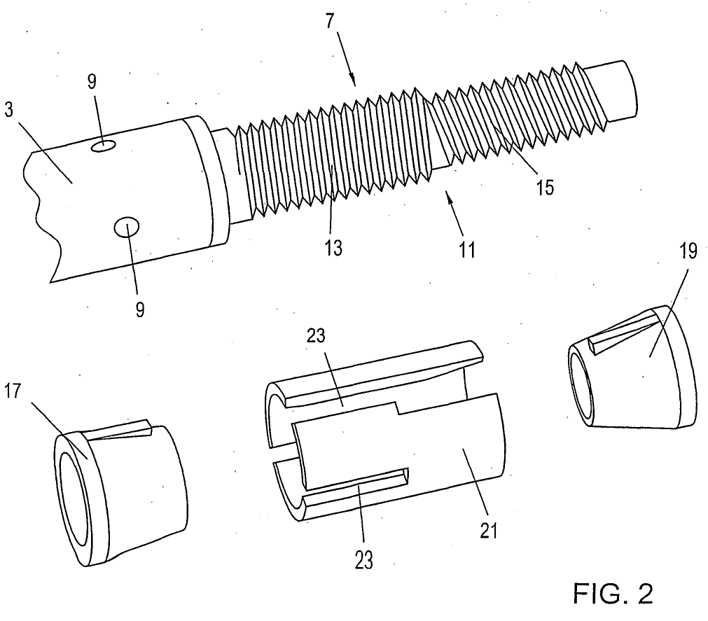

FIG. 2 shows the individual parts of the clamping device as claimed in the invention likewise without an outer tube;

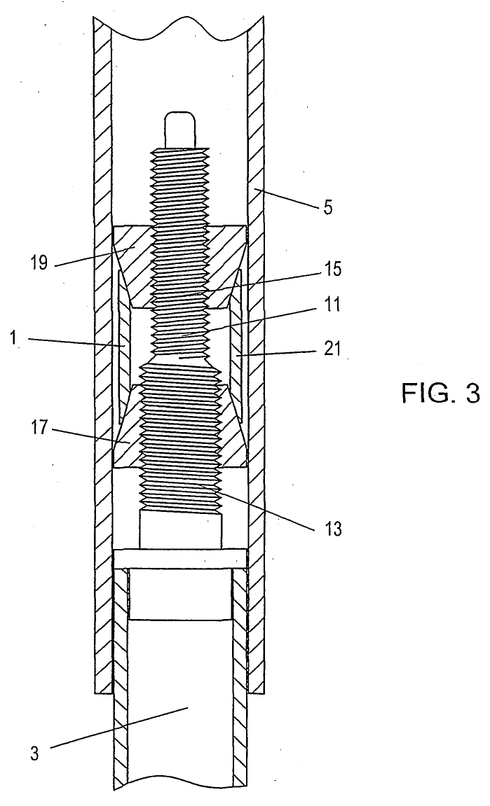

FIG. 3 shows the clamping device in the overlapping area of two tubes in an axial section; and

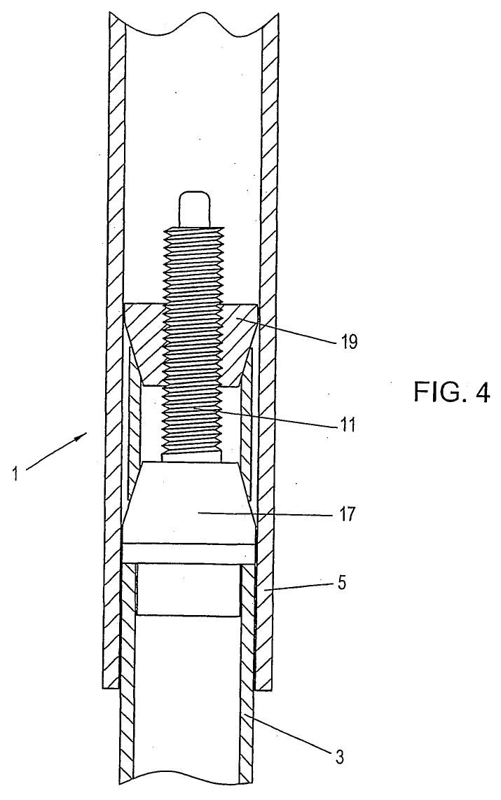

FIG. 4 shows a modified embodiment in the axial section.

The clamping device 1 as claimed in the invention is located on the end of the tube 3 (or rod) which is inserted into the outer tube 5, preferably with little play. By moving the tubes 3 and 5 toward one another, the relative position of the tubes 3, 5 to one another can be changed, and for example the length of a sports pole or staff (ski pole, hiking staff, and the like) can be set to the value desired at the time.

In particular, the clamping device 1 comprises a threaded part 7 which is fixed to the tube 3 by notches 9; its threaded rod 11 which projects over the tube 3 has two sections 13 and 15 with opposite threads. Here the thread of the section 13 which is adjacent to the tube 3 is made with a larger diameter than the thread of the threaded section 15 in the area of the free end of the threaded rod 11.

The clamping device 1 has two conical expansion bodies 17 and 19. The expansion body 17 has an internal thread which corresponds to the thicker thread 13 on the root of the threaded rod 11. The expansion body 19 has an internal thread which corresponds to the thinner thread 15 on the free end of the threaded rod 11.

Between the expansion bodies 17 and 19 there is a radially expandable (widenable) clamping part 21 which the conical expansion bodies 17 and 19 engage with their ends of smaller diameter. The clamping part 21 is a cylinder tube which has recesses 23 which lead roughly to the lengthwise center from the two sides. The recesses 23 on one end of the clamping part 21 are preferably arranged offset for example by 90° relative to the recesses 23 on the other end of the clamping part 21. In addition, the cylinder tube which forms the clamping part 21 is made continuously slotted (slot 25). Thus the clamping part 21 can be radially expanded under the action of the expansion bodies 17 and 19.

The clamping device 1 engages the interior of an outer tube 5 which is pushed over the tube 3 which is equipped with the clamping device 1, the ends of the expansion bodies 17 and 19 of greater diameter being dimensioned such that they adjoin the inner surface of the outer tube 5 by frictional engagement. In addition, the expansion bodies 17 and 19 on their thicker ends (ends with the larger diameter) can be equipped with means which increase friction. They can be for example ribs, teeth or also annular inserts of a (rubber-elastic) material which has a high coefficient of friction compared to the material of the outer tube 5.

When the tube 3 to which the clamping device is attached is turned relative to the other tube 5, for a corresponding direction of rotation the expansion bodies 17 and 19 are caused to approach one another and penetrate further into the ends of the clamping part 21 and essentially uniformly widen it radially over its length until it securely adjoins the inner surface of the outer tube 5 such that it can no longer be shifted relative to the other tube 3.

A simplified embodiment of the clamping device 1 as claimed in the invention is also considered in which its the end of the tube 3 [sic] on which there is the clamping device 1 the expansion body 17 which is provided is not movable, but stationary (FIG. 4). For example, the expansion body 17 is made integral with the threaded part 7 which is fixed in the tube 3 or is simply screwed down on the threaded rod 11 which has only one threaded section in this embodiment. In this embodiment, by rotary motion of the tubes 3 and 5 against one another axial motion of the second expansion cone 19 also arises so that the expansion bodies 17 and 19 engage the clamping part 21 from the two sides and radially widen it, as in the embodiment explained above using FIGS. 1 to 3.

All components of the clamping device 1 as claimed in the invention can be made of plastic, for the expansion bodies 17 and 19 a plastic being preferred which has relatively great friction on the inside surface of the tube (generally a metal tube).

In summary, one embodiment of the invention can be explained as follows:

In order to fix the position of telescoping tubes 3 and 5 of poles or staffs used in sports, especially ski poles, relative to one another, there is a clamping device 1 within the tubes 3 and 5. The clamping device 1 has a clamping part 21 and expansion bodies 17 and 19 which are assigned to the ends of the clamping part 21. The expansion bodies 17 and 19 are screwed onto a threaded rod 11 with opposite threaded sections 13 and 15. By relative turning of the tubes 3 and 5 to one another the expansion bodies 17 and 19 penetrate into the clamping part 21 from the two ends of the clamping part 21 for a correspondingly chosen direction of rotation and essentially uniformly widen it radially over its entire length so that with a friction connection it adjoins the inside surface of the outer tube 5 and thus fixes the length of the pole once it has been set.

1-12. (canceled)

13. Clamping device (1) for telescoping tubes (3, 5), especially of poles or staffs used in sports, with a radially expandable clamping part (21) which is a hollow cylinder which has a continuous lengthwise slot (25), conical expansion bodies (17, 19) being assigned to the two ends of the clamping part (21), characterized in that the two expansion bodies (17, 19) can be moved relative to the clamping part (21), that the expansion bodies (17, 19) are screwed onto threaded sections (13, 15) of the threaded rod (11) with opposing threads, and that a threaded part (7) which has a threaded rod (11) is attached to the inner tube (3) of the telescoping tubes (3, 5).

14. Clamping device as claimed in claim 13, wherein the threaded section (13) which is adjacent to the inner tube (3) has a greater diameter that the threaded section (15) which is remote from the inner tube (3).

15. Clamping device as claimed in claim 13, wherein the hollow cylinder which forms the clamping part (21) has recesses (23) which proceed from its two ends.

16. Clamping device as claimed in claim 15, wherein there are two recesses (23) which are diametrically opposite one another on each end of the hollow cylinder.

17. Clamping device as claimed in claim 15, wherein the recesses (23) are offset by 90 degrees to one another on the ends of the hollow cylinder.

18. Clamping device as claimed in claim 13, wherein the expansion bodies (17, 19) with their ends of smaller diameter engage the clamping part (21).

19. Clamping device as claimed in claim 13, wherein the expansion bodies (17, 19) on their ends with the greater diameter are made to increase friction relative to the material of the outer tube (5).

20. Clamping device as claimed in claim 14, wherein the hollow cylinder which forms the clamping part (21) has recesses (23) which proceed from its two ends

21. Clamping device as claimed in claim 16, wherein the recesses (23) are offset by 90 degrees to one another on the ends of the hollow cylinder.
